(19) United States
(12) Patent Application Publication
(10) Pub. No.: US 2008/0007145 A1
(43) Pub. Date: Jan. 10, 2008

(54) BICYCLE WITH AT LEAST ONE GENERATOR

(76) Inventor: Yen-Yu Lin, Banciao City (TW)

Correspondence Address: PATENTTM.US, P. O. BOX 82788, PORTLAND, OR, 97282-0788, US

(21) Appl. No.: 11/456,065

(22) Filed: Jul. 6, 2006

(51) Int. Cl. B62J 6/12; H02K 7/18; F21L 13/00

(52) U.S. Cl. 310/75 C; 310/67 A; 362/192

(57) ABSTRACT

A bicycle has multiple electrical devices and a front and rear wheel assembly, each having a fork with two tines and a wheel with an inner support structure. Moreover, at least one generator is mounted on the wheel assemblies. Each generator has multiple coil devices and multiple permanent magnets. The coil devices are mounted on the tines of at least one fork. The permanent magnets are mounted on the inner support structure of at least one wheel, correspond to and align with the coil devices and generate an electrical current in the coil devices when the wheel rotate. Since no frictional forces are required to drive the generator, the efficiency is higher, and the operation of the bicycle does not interfered by the generator.

### BACKGROUND OF THE INVENTION

1. Field of the Invention

The present invention relates to a bicycle, and more particularly to a bicycle with at least one generator.

2. Description of Related Art

A conventional bicycle with generator having a frame, two forks, two wheels usually mounted on the frame or forks of the bicycle and at least one generator comprising a casing, a generating coil and an armature. The generating coil is mounted inside the casing and has electrical leads protruding from the casing. The armature is mounted rotatably in the casing inside the generating coil and has a generating end and a driving end. The generating end is inside the generating coil and has multiple permanent magnets. The permanent magnets are mounted around the generating end and correspond to the generating coil. The driving end of the armature extends out of the casing and has a drive roller or wheel. The drive roller or wheel is attached to the drive end, presses against and is rotated by a wheel of the bicycle and rotates the armature that generates an electrical current in the generating coil.

However, the conventional bicycle with generators as described have numerous disadvantages such as low efficiency, interference with operation of the bicycle, troublesome maintenance, unregulated power that is inadequate to perform a recharging function and the like.

To overcome the shortcomings, the present invention provides a bicycle to obviate or mitigate the aforementioned problems.

### SUMMARY OF THE INVENTION

The main objective of the present invention is to provide a bicycle with at least one generator, which does not interfered by the at least one generator when operating and furthermore, generates current with high efficiency and can recharge current.

To achieve the objective, the bicycle with at least one generator in accordance with the present invention having two forks, each with two tines, two wheels, at least one generator and a controller.

Each generator comprises multiple coil devices and multiple permanent magnets.

The coil devices are mounted on opposite tines of a fork respectively.

The permanent magnets are mounted on a wheel in the fork with the coil devices and correspond to the coil devices. Opposite poles of adjacent permanent magnets are mounted next to each other. When the wheels rotate, the permanent magnets pass between the coil devices and generate electricity that is transmitted to the controller.

The controller is mounted on the bicycle, electrically connects to the coil devices and multiple electrical devices mounted on the bicycle like lights, turn signals, horns, etc. and comprises a variety of control circuits and a built-in rechargeable member. The control circuits rectify, filter and transform voltage of electrical current generated and used on the bicycle. The rechargeable member stores electrical energy and may be a rechargeable battery.

Since the coils and the permanent magnets generate electricity without any contact with the wheels, the generator has higher efficiency and interference with operation of the bicycle is nil. Furthermore, since electrical energy is stored in the controller, the electrical device on the bicycle can be operated even when the wheels are not rotating.

Other objectives, advantages and novel features of the invention will become more apparent from the following detailed description when taken in conjunction with the accompanying drawings.

### BRIEF DESCRIPTION OF THE DRAWINGS

FIG. 1 is a side view of a first embodiment of a bicycle with two generators in accordance with the present invention;

FIG. 2 is a side view of a second embodiment of a bicycle with two generators in accordance with the present invention;

FIG. 3 is a side view of a third embodiment of a bicycle with two generators in accordance with the present invention;

FIG. 4 is a front view of a front fork of the bicycle in accordance with the present invention with individual coils wound respectively on tines of the fork;

FIG. 5 is a front view of a front fork of the bicycle in accordance with the present invention with coil assemblies mounted respectively on tines of the fork; and

FIG. 6 is a block diagram of the controller on the bicycle in FIG. 1.

### DETAILED DESCRIPTION OF THE PREFERRED EMBODIMENT

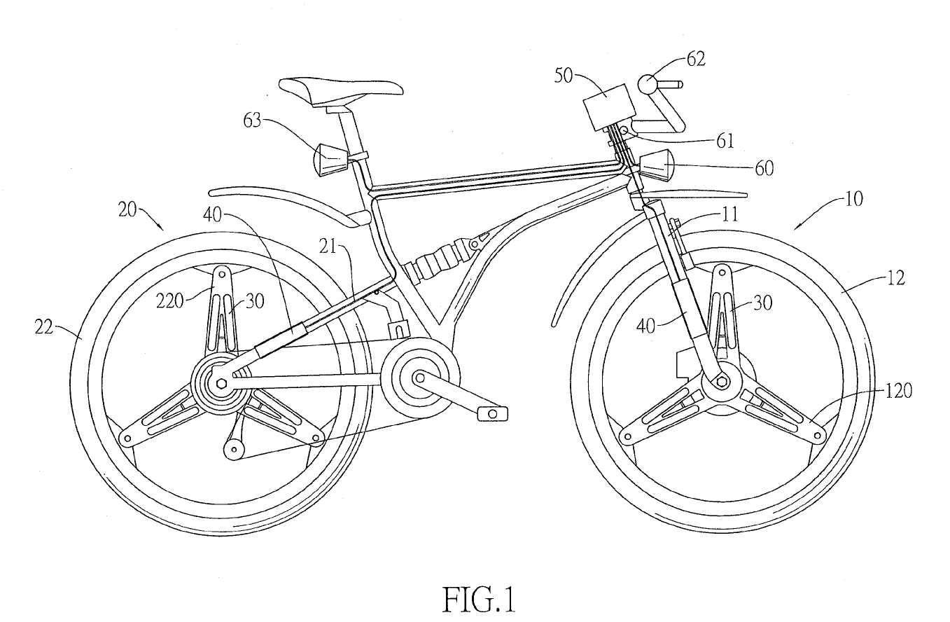

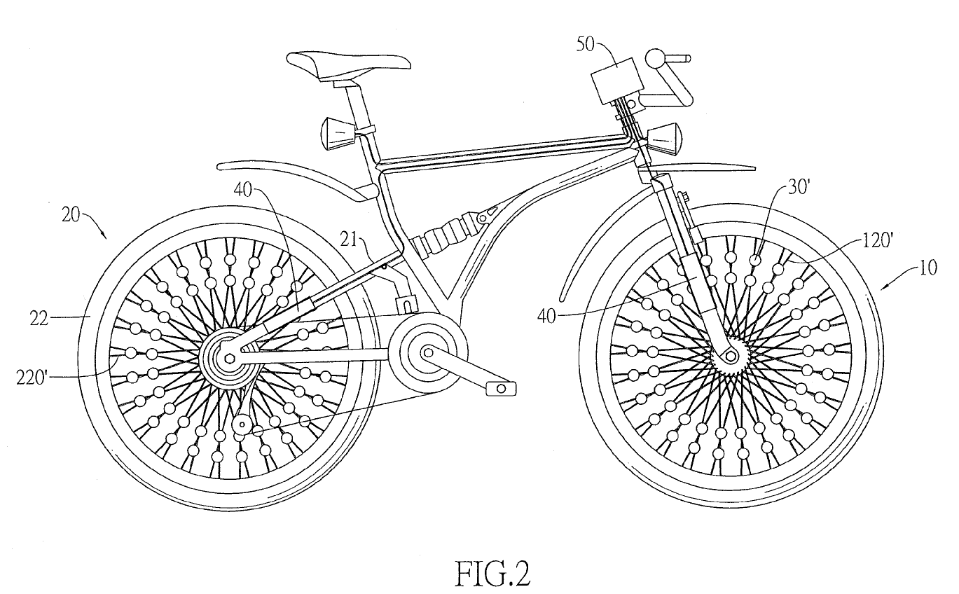

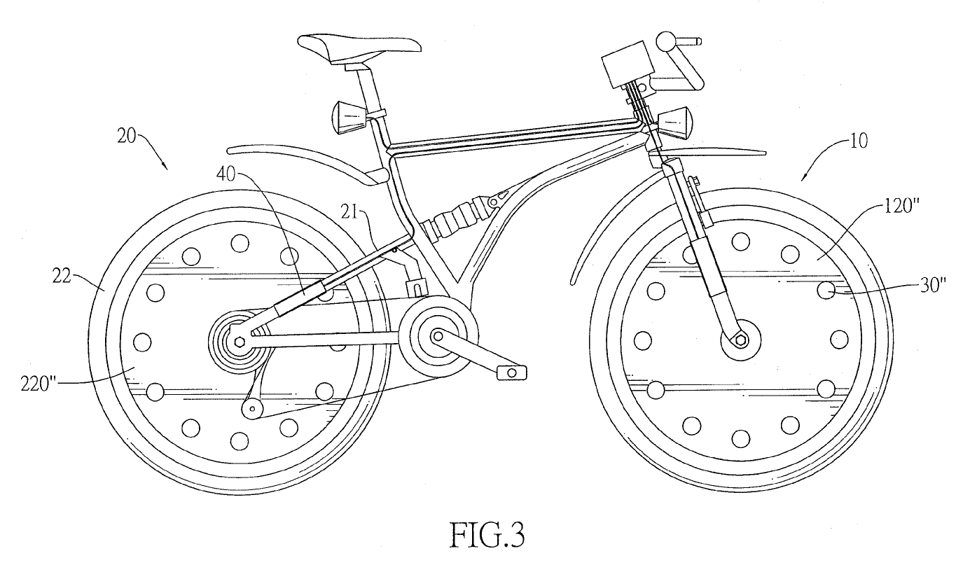

With reference to FIGS. 1, 2 and 3, a bicycle comprises multiple electrical devices, a front wheel assembly (10), a handlebar and a rear wheel assembly (20), two generators and a controller (50).

The electrical devices including a headlight (60), a horn (61), turn signals (62), a tail light (63) and the like.

The front wheel assembly (10) has a front fork (11) and a front wheel (12). The front fork (11) has two tines. The front wheel (12) is mounted rotatably between the tines of the front fork (11) and has a hub, a rim and an inner support structure. The inner support structure is formed between the hub and the rim, has two sides and may be implemented with multiple radial struts (120), multiple spokes (120′) or a disk (120″).

The handlebar is attached to the front wheel assembly (10).

The rear wheel assembly (20) has a rear fork (21) and a rear wheel (22). The rear fork (21) has at least two tines. The rear wheel (22) is mounted rotatably between the tines of the rear fork (21) and has a hub, a rim and an inner support structure. The inner support structure is formed between the hub and the rim, has two sides and may be implemented with multiple radial struts (220), multiple spokes (220′) or a disk (220″).

The generators are mounted in the front wheel assembly (10) and the rear wheel assembly (20) respectively, each generator comprises two coil device (40, 40′) and multiple permanent magnets (30, 30′, 30″)

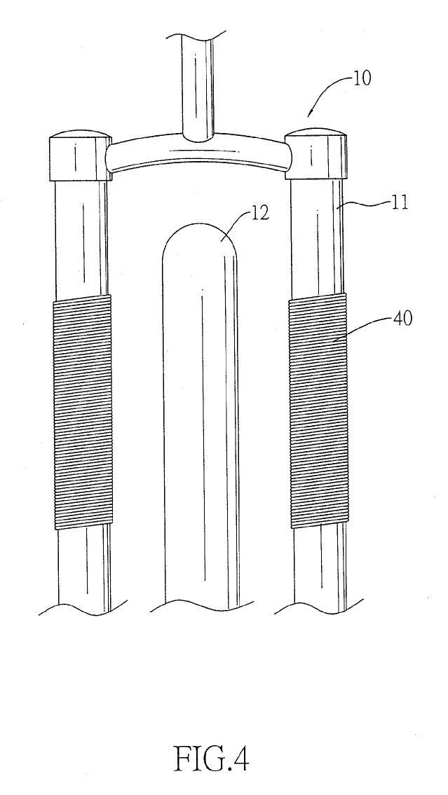

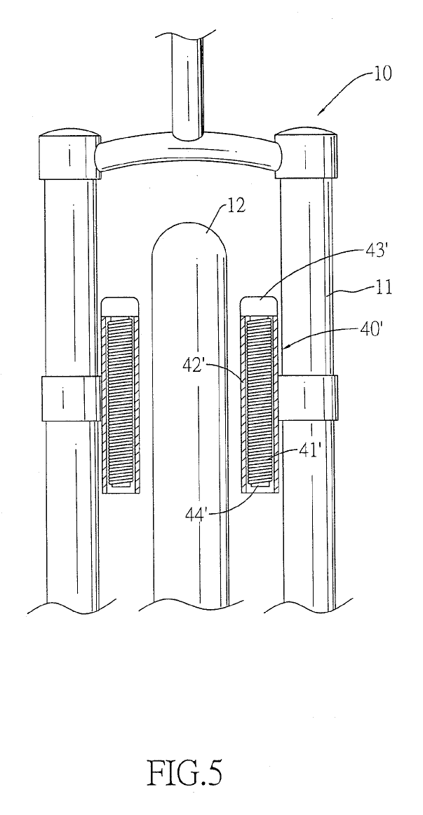

With further reference to FIGS. 4 and 5, the coil devices (40, 40′) are mounted on the tines of at least one fork (11, 21) of the wheel assemblies (10, 20) and may be implemented as multiple individual coils (40) or multiple coil assemblies (40′).

The individual coils (40) are wound respectively on the tines of at least one fork (11, 21).

The coil assemblies (40′) are mounted respectively on tines of at least one fork (11, 21), and each coil assembly (40′) comprises two holders (42′), two end caps (43′), two cores (44′) and two coils (41′). The holders (42′) are tubular, are mounted respectively on tines of a fork (11, 21) and align with each other. The end caps (43′) are detachably mounted respectively on the holders (42′). The cores (44′) may be iron, are securely attached respectively to the end caps (43′) and extend respectively into the holders (42′) when the end caps (43′) are mounted on the holders (42′). The coils (41′) are wound respectively on the cores (44′).

The permanent magnets (30, 30′, 30″) are mounted at intervals around the inner support structure of at least one of the wheels (12, 22) with opposite poles on adjacent permanent magnets (30, 30′, 30″) corresponding to each other, align with the coil device (40, 40′) and induce an electrical current in the coils (40, 41′) when the at least one wheel (12, 22) rotates.

In a first embodiment of the generator in accordance with the present invention, the permanent magnets (30) are bar-shaped and mounted respectively on the struts (120).

In a second embodiment of the generator in accordance with the present invention, the permanent magnets (30′) are circular and are mounted on the spokes (120′).

In a third embodiment of the generator in accordance with the present invention, the permanent magnets (30″) are circular and are mounted on the support disks (120″).

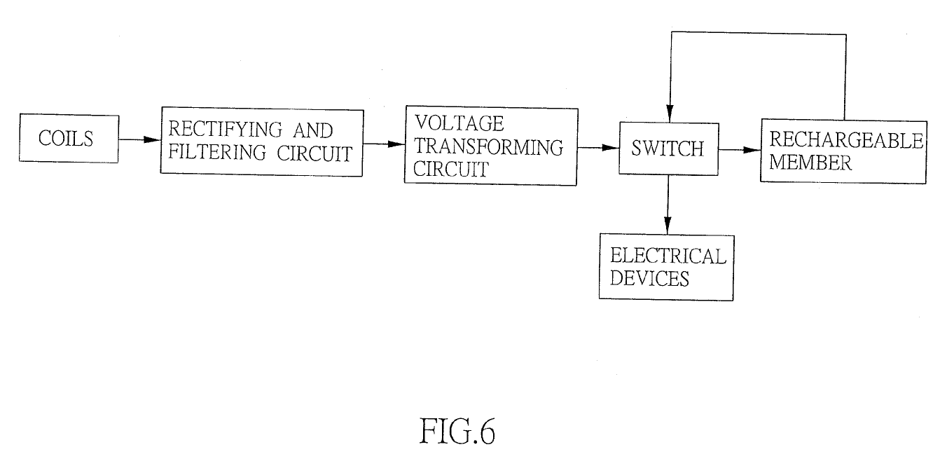

With further reference to FIG. 6, the controller (50) is mounted detachably on the bicycle, may be mounted detachably on the handlebar, electrically connects to the coils (40, 41′) and the electrical devices, and has a rechargeable member and multiple circuits. The rechargeable member is mounted in the controller (50) and may be a rechargeable battery. The circuits are mounted in the controller (50) and include a rectifying and filtering circuit, a voltage transforming circuit and a switch. The electrical current generated from the coils is used to operate electrical devices and to charge the rechargeable battery.

The bicycle with generator in accordance with the present invention is completely obviates any wear due to friction between the generator and the interference due to misalignment between the generator and the wheel.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A bicycle comprising
at least two wheel assemblies, each wheel assembly having a fork with two tines and a wheel mounted rotatably between the tines and having a hub, a rim and an inner support structure formed between the hub and the rim and having two sides;
at least one generator each comprising
multiple coil devices being mounted respectively on the tines of the fork of a corresponding one of the wheel assemblies; and
multiple permanent magnets being mounted at intervals around the inner support structure of the wheel of the corresponding wheel assembly and aligning with the coil devices to induce an electrical current in the coils when the wheel rotates.

2. The bicycle claimed in claim 1, further comprising a controller being mounted detachably on the bicycle, electrically connecting to the coil devices and having
a rechargeable member being mounted in the controller; and
multiple circuits being mounted in the controller for rectifying, filtering and transforming electrical voltage and directing electrical current to charge the rechargeable member.

3. The bicycle as claimed in claim 1, wherein the coil devices of each one of the at least one generator are implemented as individual coils wound respectively on tines of the fork of the corresponding wheel assembly.

4. The bicycle as claimed in claim 1, wherein the coil devices of each one of the at least one generator are implemented as multiple coil assemblies mounted respectively on tines of the fork of the corresponding wheel assembly, and each coil assembly comprises
two holders being tubular and mounted respectively on tines of the fork of the corresponding wheel assembly and aligning with each other;
two end caps being detachably mounted respectively on the holders;
two cores being securely attached respectively to the end caps and extending respectively into the holders; and
two coils being wound respectively on the cores.

5. The bicycle as claimed in claim 1, wherein
the inner support structures of the wheels are multiple radial struts; and
the permanent magnets are bar-shaped and are mounted respectively on the struts.

6. The bicycle as claimed in claim 1, wherein
the inner support structures of the wheels are multiple spokes; and
the permanent magnets are circular and are mounted respectively on the spokes.

7. The bicycle as claimed in claim 1, wherein
the inner support structures of the wheels are disks; and
the permanent magnets are circular and are mounted on the disks.

8. The bicycle as claimed in claim 2, wherein the rechargeable member of the controller is a rechargeable battery.

9. The bicycle as claimed in claim 4, wherein the cores are made of iron.

10. The bicycle as claimed in claim 1, further comprising multiple electrical devices electrically connecting to the controller.
